(19) United States
(12) Patent Application Publication
(10) Pub. No.: US 2013/0160518 A1
(43) Pub. Date: Jun. 27, 2013

(54) RELATIVE HUMIDITY SENSOR AND METHOD FOR CALIBRATION THEREOF

(71) Applicants: Olivier LENEEL, Singapore (SG); Ravi SHANKAR, Singapore (SG)

(72) Inventors: Olivier LENEEL, Singapore (SG); Ravi SHANKAR, Singapore (SG)

(73) Assignee: STMICROELECTRONICS ASIA PACIFIC PTE LTD., Singapore (SG)

(21) Appl. No.: 13/335,289

(22) Filed: Dec. 22, 2011

(51) Int. Cl. G01N 27/22; G01N 27/12

(52) U.S. Cl. 73/1.06; 73/335.02; 73/335.04

(57) ABSTRACT

A device having an integrated circuit that includes a relative humidity sensor as well as a memory element for storing calibration information for the relative humidity sensor. Because of the nature of fabrication of an integrated circuit for a relative humidity sensor, variances in the creation of electronic components therein may lead to a need to calibrate the sensor after assembly. Such calibration information may be ascertained at the time of fabrication and stored in a memory component disposed on the integrated circuit chip. By storing the calibration information, which may be determined at the time of fabrication, one does not need to determine such calibration information later at assembly or store the already determined calibration information in a remote location until assembly if it was, in fact, ascertained at fabrication. Then, at assembly, one needs only to read the calibration information in order to calibrate the relative humidity sensor.

### BACKGROUND

Humidity is a commonly used term in describing meteorological conditions as a measure of an amount of water vapor in the air. One way to measure humidity is to measure the absolute amount of water vapor in a mixture—called absolute humidity. Humidity may be expressed in many ways, but the one commonly used expression of humidity is relative humidity. Relative humidity is defined as the partial pressure of water vapor in the air-water mixture, given as a percentage of the saturated vapor pressure under specific pressure and temperature conditions. Thus, when used to describe meteorological conditions, the relative humidity of air may change not only with respect to the absolute humidity (moisture content) but also ambient temperature and pressure. Relative humidity is often used instead of absolute humidity in situations where the rate of water evaporation is important, as it takes into account the variation in saturated vapor pressure.

Relative humidity may be measured by an electronic sensor having a dedicated pair of capacitor plates (or several cooperative pairs), i.e., a relative humidity sensing capacitor. Under known temperature and pressure conditions, one can measure a capacitance between the plates that may be translated into a specific relative humidity. As the relative humidity may rise or fall, so too does the electrical characteristics of the sensing capacitor. Thus, by calibrating a circuit for interpreting the electrical characteristics of the sensing capacitor, one may measure relative humidity under other temperature and pressure conditions as well by monitoring the charge on the sensing capacitor.

Such a sensing capacitor and measurement circuitry may be realized on an integrated circuit chip and calibrated at the time of manufacture. However, it is often the case that a wafer having many IC chips created therein is manufactured at one time while the actual electronic devices containing the manufactured IC chips are assembled and calibrated at a later time and often at a different facility. Thus, individually calibrating each electronic device at the time of assembly becomes time consuming and keeping track of calibration information form the time of IC chip manufacture becomes tedious and burdensome.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows a block diagram of a device having a relative humidity sensor formed according to an embodiment of the subject matter disclosed herein;

FIG. 2 shows a graph of capacitance curve plots of the sensing capacitor of the device of FIG. 1 according to an embodiment of the subject matter disclosed herein;

FIG. 3 shows a flow chart of a method for determining and storing calibration information for the device of FIG. 1 according to an embodiment of the subject matter disclosed herein;

FIG. 4 shows a flow chart of a method for calibrating the device of FIG. 1 according to an embodiment of the subject matter disclosed herein; and

FIG. 5 shows a block diagram of a system for determining calibration information for the device of FIG. 1 according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein may be directed to a device having a single integrated circuit that includes a relative humidity sensor as well as a memory element for storing calibration information for the relative humidity sensor. Because of the nature of fabrication of an integrated circuit for a relative humidity sensor, variances in the creation of electronic components therein may lead to a need to calibrate the sensor after assembly. Such calibration information may be ascertained at the time of fabrication and stored in a memory component disposed on the integrated circuit chip. By storing the calibration information, which may be determined at the time of fabrication, one does not need to determine such calibration information later at assembly or store the already determined calibration information in a remote location until assembly if it was, in fact, ascertained at fabrication. Then, at assembly, one needs only to read the calibration information directly from the integrated circuit in order to calibrate the relative humidity sensor.

Such a method and system saves time and test costs during assembly as any calibration information for a specific integrated circuit chip is already stored on the integrated circuit chip. Further, by storing such calibration information directly on the chip, the need to keep track of calibration information in a separate database is eliminated. This saves time and effort and reduces any chance of losing the information or misinterpreting the separately stored information.

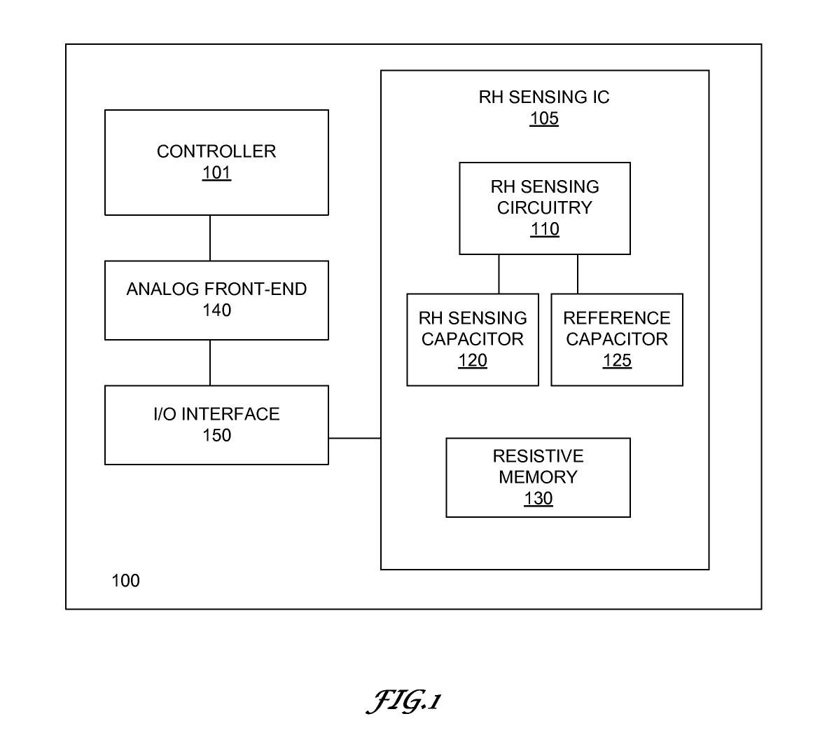

FIG. 1 shows a block diagram of a device 100 having an integrated circuit 105 for determining relative humidity formed according to an embodiment of the subject matter disclosed herein. The device 100 may include a sensing integrated circuit (IC) 105 that includes at least one reference capacitor 125 and at least one relative humidity sensing capacitor 120 created at the time of fabrication. A skilled artisan understands that the IC 105 may include multiple reference and sensing capacitors as well as other electronic circuitry, but for the purpose of this disclosure going forward, only one reference capacitor 125 and only one sensing capacitor 120 will be discussed.

The reference capacitor 125 may comprise metal plates (as may be common with most typical integrated circuit capacitors) and is used to establish a reference capacitance during measurement to establish calibration information for the sensing capacitor 120. The capacitance of the reference capacitor 125 is capped to be insensitive to changes in ambient humidity. The sensing capacitor 120, however, includes two parallel metal plates each having covering films with a polyimide dielectric layer. In a known manner, absorption of moisture by the polyimide dielectric layer changes the dielectric constant of the capacitor. As such, be knowing a constant reference capacitance (established by reference capacitor 125), one may calculate a relative humidity by measuring the change in the capacitance of the sensing capacitor 120 because the capacitance changes with humidity of the ambient conditions. Then, along with associated relative humidity sensing circuitry 110 on the IC 105 and an analog front-end circuit 140 coupled to the IC 105, the relative humidity of ambient conditions may be determined.

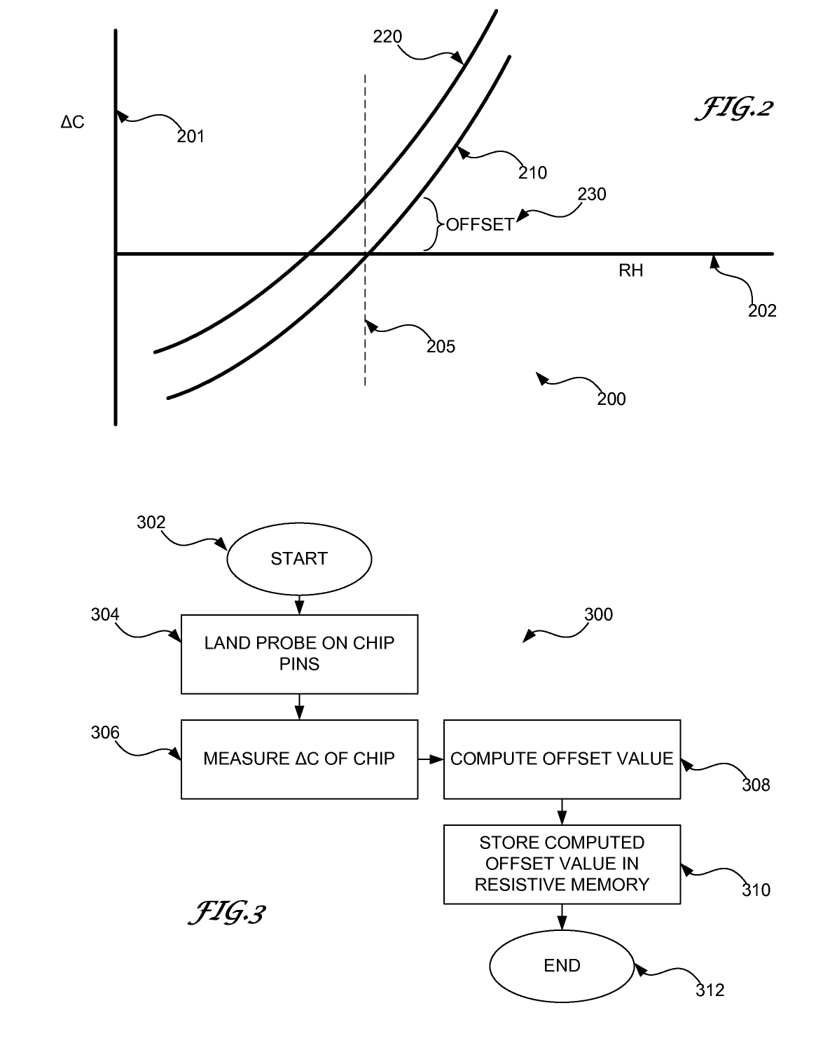

During the fabrication process, each IC 105 die may include small variances that lead to differences in the capacitance of the sensing capacitor. The difference in capacitance may be measured in the form of a direct current offset (DC offset) and it will vary from die to die. The DC offset is illustrated in greater detail below with respect to FIG. 2. At the wafer level during fabrication, each integrated circuit 105 may also be fabricated with a resistive memory element 130 that may be used to indicate calibration information for the eventual assembly of a relative humidity sensor. Such a memory element 130 may be used to store information about the DC offset.

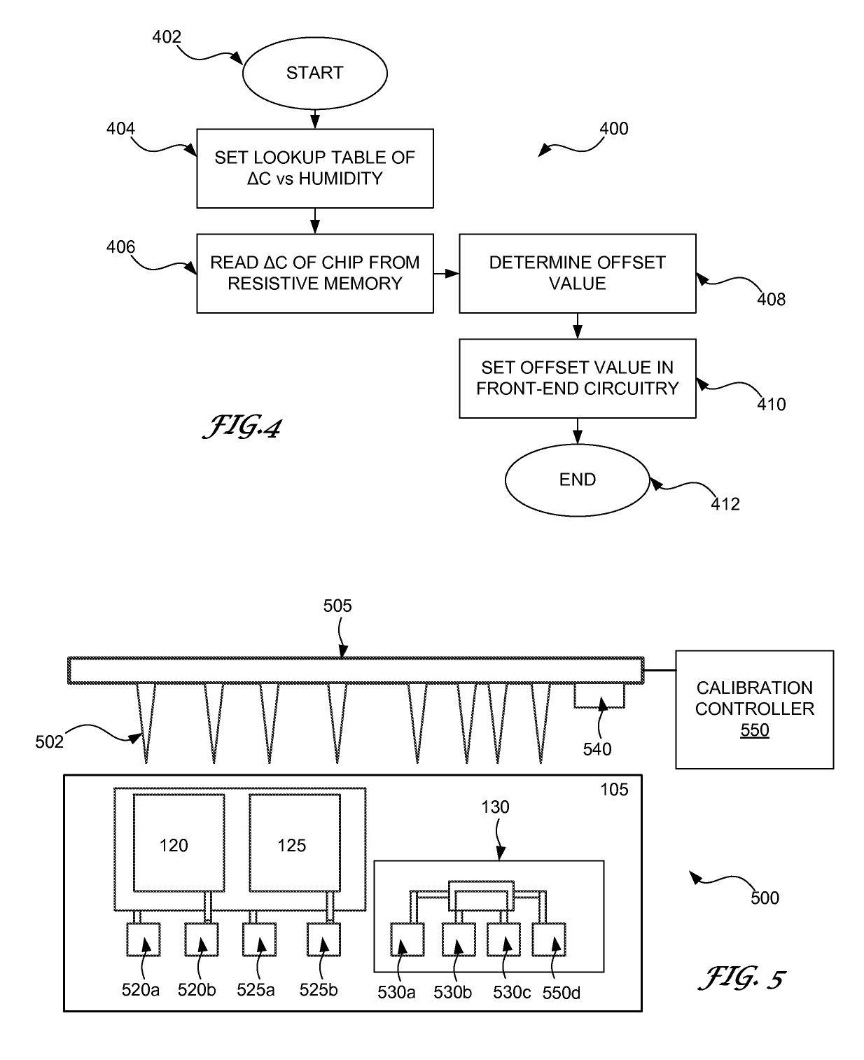

As will be described in further detail below with respect to FIG. 5, each integrated circuit 105 may be probed during fabrication at the wafer stage within known temperature and pressure conditions to establish calibration information. Such information cannot be properly used until assembly of the overall device where a controller 101 may introduce the DC offset to compensate for the variance in the capacitor fabrication based upon the stored calibration information. Thus, this calibration information is stored in the memory element 130 until assembly.

To store the calibration information, a probe (not shown in FIG. 1) may engage the integrated circuit 105 to set the resistive memory element 130 during the wafer level of fabrication or once the wafer has been diced into separate die level. Such a resistive memory element 130 is described in U.S. Patent Publication 2010/0073122, entitled “DUAL THIN FILM PRECISION RESISTANCE TRIMMING” which is incorporated herein by reference in its entirety. Thus, the resistive memory element 130 may be exposed to heat via the probe in order to set the resistance of the element (i.e., trim the resistor) to a specific value which corresponds to a particular DC offset value for the calibration information determined. This is advantageous over other methods of trimming an on-chip resistor such as laser trimming because of less complexity and precision that is required.

The device may further include an I/O interface 150 coupled to the controller 101 and coupled to the sensing IC 105 such that a relative humidity may be displayed to a user or such that a user may enter input data so as to manipulate the device. Such an I/O interface 150 is not discussed in any further detail herein. Thus, at assembly, the stored information in the memory element 130 may be read and used to determine a DC offset with which to calibrate the controller 105. Such a calibration is illustrated in greater detail now with respect to FIG. 2.

FIG. 2 shows a graph 200 of capacitance curve plots of a capacitor similar to the sensing capacitor 120 of the device of FIG. 1 according to an embodiment of the subject matter disclosed herein. This graph 200 plots the capacitance 201 against a relative humidity 202 based upon known conditions previously established. Thus, a zero crossing may be known at a specific pressure and temperature control parameter 205 such that a known capacitor would yield a plot 210 that crosses at the zero crossing at an expected relative humidity. One can see from the curve of this plot 210 that as the relative humidity 202 increases along the x-axis, then so too does the magnitude of the capacitance along the y-axis. Once an initial plot 210 is established, any other capacitor with unknown fabrication parameters may be plotted against the known plot 210. Thus, a second unknown capacitor plot 220 may be generated and compared against the known plot 210 to determine a specific difference at the known temperature and pressure point 205. This difference may be measured as a specific DC offset, that when known by a controller (such as controller 101 of FIG. 1), can be compensated. Such compensation is known as calibrating the controller 101. Measuring for this calibration information, storing it, and then using it to calibrate a device is descried further in the methods illustrated in the flow charts of FIGS. 3 and 4 below.

FIG. 3 shows a flow chart of a method for determining and storing calibration information for the device of FIG. 1 according to an embodiment of the subject matter disclosed herein. The method may begin at step 302 after a wafer of ICs (like the IC 105 of FIG. 1) have been fabricated but before any information is known about RH sensing capacitors disposed therein. A probe specifically designed to engage a wafer of RH sensing ICs may then be set into position to engage specific pins of each IC in the wafer at step 304. Alternatively, each chip may be individually engaged by a probe designed to engage a single chip at a time in a wafer of chips.

Next, at step 306, signals passed through the probe are able to determine the capacitance of an engaged sensing capacitor as well as an engaged reference capacitor to determine the curves as discussed above in FIG. 2. With such information established, a DC offset may then be calculated at step 308. In past solutions, this DC offset as computed would need to be stored in an off-chip database and then later used during calibration of the device in which this particular chip was deployed. However, in an advantageous manner, this DC offset value may be stored in an on-chip memory element by trimming the resistive element at step 310. The calibration data storage ends at step 312. Now that the DC offset is stored in the form of a specific resistance of the resistive element, device calibration and assembly is simpler as discussed in the method shown in the flow chart of FIG. 4.

FIG. 4 shows a flow chart of a method for calibrating the device of FIG. 1 according to an embodiment of the subject matter disclosed herein. The calibration method begins at step 402 when a RH sensor IC has already been fabricated and set into a device such as the device 100 of FIG. 1. Thus, the controller 101 of FIG. 1 is communicatively coupled to the IC 105 via front-end circuitry 140. At step 404, a lookup table may be established/instantiated that includes a cross reference of capacitance difference (reference vs. sensing) against resistances that may be read from the resistive element. This lookup table may be part of a calibration system (not shown separately) that is not part of the overall RH device or may be stored in non-volatile memory within the RH device. In another embodiment, this lookup table may be stored in a non-volatile memory within the RH device.

Next, the previously trimmed resistive element 120 may be read via the front-end circuitry at step 406. Based on the read resistance, the controller 101 may then determine a specific DC offset from the lookup table at step 408. Then the controller 101 may set the determined DC offset in a memory in the front-end circuitry 140 at step 410. The device 100 is now calibrated with the stored DC offset established in the front-end circuitry 140 and the calibration method ends at step 412. The methods of FIGS. 3 and 4 may be accomplished within one or more components described in the system of FIG. 5.

FIG. 5 shows a block diagram of a system for determining calibration information for the device of FIG. 1 according to an embodiment of the subject matter disclosed herein. As can be seen, an exploded view of various components of the IC 105 from the device 100 from FIG. 1 is shown in greater detail and not to scale. Thus, the IC 105 as shown includes a reference capacitor 125 and a sensing capacitor 120, each having a pair of I/O pads 125a/b and 120a/b respectively. Further, the IC 105 includes the resistive memory element 130 having four pads 130a-d itself for trimming and reading. The IC 105 may be engaged with a probe 505 from the calibration system 500 such that at least one probe pin 502 is operable to engage with each of the pins from the components on the IC 105. Through the probe pins 502, the calibrator controller 550 may determine calibration information for any IC 105 that is engaged with the calibration system 500.

In one embodiment, the calibration controller may cause signals to flow through appropriate probe pins 502 engaged with the I/O pads 125a/b of the reference capacitor and I/O pads 120a/b of the sensing capacitor. By measuring the response of these two capacitors 125 and 120 under known temperate and pressure conditions, the calibration controller can establish the two curves as illustrated and discussed previously with respect to FIG. 2. Thus, a DC offset may be calculated by the calibration controller 550 that corresponds to the difference in capacitance of the reference capacitor 125 and the sensing capacitor 120. Further, the reference capacitor may be compared to an established and pre-calibrated capacitor 540 on the probe itself. This comparison may further affect the calculated DC offset.

With the calculated DC offset now known for this particular IC 105, the resistive memory element 130 may be trimmed to have a resistor value that corresponds to the calculated DC offset. This may be accomplished by applying signals to the I/O pins 130a-d of the resistive element 130 in the manner described in the incorporated patent application identified previously. Thus, the resistive element 130 may now have a resistance that can be read by a device controller (such as controller 101 of FIG. 1) to establish a DC offset based upon a lookup table stored in a memory of the overall device.

With such calibration information now stored, the eventual device in which this particular IC 105 ends up in may be calibrated by the device itself by reading the resistance of the now trimmed resistive element 130 (as described above with respect to FIG. 4). This is because for each sensor there the measurable and precise response of relative humidity against a difference in capacitance of eth sensing capacitor such the relative humidity is a linear function of temperature and any DC offset introduced:

RH=f(T,DC)

By design setup of the analog front-end 140 of the eventual device, the DC offset is initially set at zero value for a relative humidity of 50% (which is simply a midway in the range of 0-100%). Then, by determining a DC offset (such as through a lookup table after measuring the resistive element), the device may then be calibrated without having to probe individual pins of the IC 105 again or by having to import stored DC offset values from a remote location.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. An integrated circuit, comprising:
a sensor; and
a resistive memory configured to store calibration information for the sensor.

2. The integrated circuit of claim 1, wherein the sensor comprises a relative humidity sensor.

3. The integrated circuit of claim 2, wherein the relative humidity sensor comprises a reference capacitor and a sensing capacitor.

4. The integrated circuit of claim 3, wherein the reference capacitor further comprises a pair of parallel metal plates that are electrically insensitive to changes in ambient humidity.

5. The integrated circuit of claim 3, wherein in the sensing capacitor further comprises metal plates covered with a polyimide dielectric layer.

6. The integrated circuit of claim 1, wherein the resistive memory further comprises

7. The integrated circuit of claim 1, further comprising a single integrated circuit die.

8. The integrated circuit of claim 1, further comprising multiple integrated circuit dies.

9. The integrated circuit of claim 1, further comprising pins disposed on the integrated circuit in a pattern suited to be engaged by a probe.

10. The integrated circuit of claim 9, wherein the pins further comprise four pins coupled to the sensor and four pins coupled to the resistive memory.

11. A device, comprising:
an integrated circuit having:
a relative humidity sensor; and
a resistive memory configured to store calibration information for the relative humidity sensor.

12. The device of claim 11, further comprising front-end circuitry configured to generate a reading based on a signal from the relative humidity sensor and adjusted by the calibration information from the resistive memory.

13. The device of claim 11, further comprising an electronic display coupled to the relative humidity sensor and configured to display a relative humidity reading based on a signal from the relative humidity sensor.

14. The device of claim 11, further comprising a processor coupled to the integrated circuit and configured to calibrate the relative humidity sensor using the calibration information stored in the resistive memory.

15. The device of claim 11, wherein the relative humidity sensor further comprises a sensing capacitor and a reference capacitor.

16. A system, comprising:
an integrated circuit having:
a relative humidity sensor having at least one I/O pad; and
a resistive memory having at least one I/O pad and configured to store calibration information for the relative humidity sensor;
a probe having probe pins configured to engage respective pads of the integrated circuit;
a probe controller coupled to the probe and configured to determine calibration information from the relative humidity sensor and configured to store the calibration information in the resistive memory.

17. The system of claim 16, further comprising a reference capacitor disposed on the probe.

18. The system of claim 16 wherein the relative humidity sensor comprises four I/O pads and the resistive memory comprises four I/O pads.

19. The system of claim 18 wherein the probe comprises eight probe pins.

20. A method for determining calibration information, the method comprising:
engaging a sensor disposed on an integrated circuit with a probe;
measuring a response to a signal introduced by the probe;
determining an offset value corresponding to the measured response; and
storing a parameter indicative of the offset value in a component disposed on the integrated circuit.

21. The method of claim 20 wherein the storing the parameter further comprising trimming a resistive memory element to have a resistance indicative of the offset value.

22. The method of claim 20 wherein the determining the offset value further comprises comparing the measured response to a reference response associated with a known component at the probe.

23. The method of claim 20 wherein the measuring is conducted at a specific test temperature and test pressure condition.

24. A method for calibrating a device, the method comprising:
reading a resistance value of a resistive element disposed on an integrated circuit with a controller coupled to the integrated circuit;
determining, at the controller, an offset value corresponding to the read resistance value; and
configuring the device to utilize the offset value.

25. The method of claim 24, wherein the determining the offset value further comprises referencing a lookup table of offset values to determine an offset value corresponding the read resistance.

26. The method of claim 24, further comprising storing the offset value in a memory in the device.

27. The method of claim 24, further comprising configuring the device to adjust a determined relative humidity by the offset value.

28. A calibration system, comprising:
a probe configured to engage an integrated circuit die; and
a controller coupled to the probe and configured to generate a test signal through one or more probes to determine a difference in a parameter between an electronic component disposed on the integrated circuit and a reference electronic component disposed on the probe.

29. The calibration system of claim 28, wherein the electronic component disposed on the integrated circuit comprises a relative humidity sensing capacitor.

30. The calibration system of claim 28, wherein the probe comprises eight probe pins configured in a pattern to engage eight I/O pads on the integrated circuit.

31. The calibration system of claim 28, wherein the reference electronic component comprises a relative humidity sensing capacitor that is calibrated to a known signal response at a known ambient temperature and a known ambient pressure.
